(19) United States
(12) Patent Application Publication
(10) Pub. No.: US 2004/0078413 A1
(43) Pub. Date: Apr. 22, 2004

(54) Device for monitoring operation of processing circuit

(76) Inventors: Takeshi Yoshimoto, Kanagawa-ken (JP); Toshiyuki Furusawa, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/348,001

(22) Filed: Jan. 22, 2003

(30) Foreign Application Priority Data
Jan. 22, 2002 (JP) 2002-13439

(51) Int. Cl. G06F 15/00

(52) U.S. Cl. 708/525

(57) ABSTRACT

A computer device includes a computer processing circuit and a software development circuit. The computer processing circuit includes a first computing component and a first command control component, the first computing component performs calculations in accordance with a first control signal and the first control signal is generated by the first command control component based on a first program. The software development and support circuit includes a second computing component and a second command control component, the second computing component calculates in accordance with a second control signal and the second command control component generates the second control signal based on a second program. The software development and support circuit receives information of computing status of the computer processing circuit as numerical data, and the second computing component processes the numerical data responsive to the said second control signal.

### CROSS REFERENCE RELATED APPLICATIONS

This application claims the benefit of priority from prior Japanese Patent Application P2002-13439, filed on Jan. 22, 2002; the contents of which are incorporated by reference herein.

### FIELD OF THE INVENTION

The present invention concerns a computing circuit for software in a semiconductor device, for example, a Digital Signal Processor (DSP) or a Reduced Instruction Set Computer (RISC).

### DESCRIPTION OF RELATED ART

The scale and complexity of software used in computer devices such as a DSP or a RISC that perform numerical calculations has increased as computer devices operate at higher speed and with greater complexity.

Software development is a process for software coding and debugging, such as detecting and correcting problems. The more complex and of greater scale a software program becomes, the more important a software development and support circuit becomes. The software development and support circuit is a computer circuit to detect and verify problems in the software. Generally, software development and support circuits are formed within specific locations of a wafer or a chip together with a computer circuit.

FIG. 1 shows a conventional digital processing circuit. A computer device 31 includes a computer processing circuit 11. Circuit 11 comprises a first command control component 32 to control operations relating to calculations, and a first computing component 33 to actually compute based upon control signals from first command control component 32. First command control component 32 has a controller 12, a program counter 13, a program memory 14, and an instruction decoder 15. First computing component 33 has an address generator 16, an address register 17, a data memory 18, an arithmetic logic unit (ALU) 19, and a data register 20.

Typically, a software development and support circuit is constructed such that data can be read with program counter 13 and data register 20. A comparator 22 retains a break point 21 during operation of the software development and support circuit and compares break point 21 with data from program counter 13. If data from program counter 13 reaches break point 21, then comparator 22 indicates that there is an interruption to process controller 12 within circuit 11. After first command control component 32 within circuit 11 has executed the interruption based on instructions from the software development support circuit, the operations of device 31 are stopped under certain specific conditions.

This is the conventional manner in which an interior status of a typical computer device, such as device 31, is verified.

Furthermore, if device 31 with circuit 11 comprises a single chip, the software development support circuit may be implemented in the same chip or in a separate chip.

The software development support circuit of the conventional computer device 31 may comprise an exclusive circuit with a simple structure, such as comparator 22. However, because the software development support circuits typically found in the art have this simple structure, the conditions under which the interior status of a computer, such as device 31, can be checked are limited.

Therefore, verification may be impossible under certain complex conditions such as, for example, checking the interior status of device 31 when commands are generated at specific times and with specified data (e.g., checking the status in real time).

### SUMMARY

In accordance with exemplary embodiments consistent with the present invention, there is provided a computer device comprising: a computer processing circuit having a first computing component and a first command control component, the first computing component for performing calculations in accordance with a first control signal, the first control signal being generated based on a first program; a software development and support circuit having a second computing component and a second command control component, the second computing component for calculating in accordance with a second control signal, the second command control component for creating the second control signal based on a second program; and wherein the software development and support circuit receives information of computing status of the computer processing circuit as numerical data, and the second computing component performs calculations on the numerical data responsive to said second control signal.

Also in accordance with embodiments consistent with the present invention, there is provided a portable information system comprising: a receiving device to receive information; a computer processing circuit, which processes said information, having a first computing component and a first command control component, the first computing component for performing calculations in accordance with a first control signal and the first control signal being generated by the first command control component based on a program; a software development and support circuit having a second computing component and a second command control component, the second computing component calculating in accordance with a second control signal, the second command control component generating the second control signal based on a program; and wherein the software development and support circuit receiving information of computing status of the computer processing circuit as numerical data, the second computing component processing the numerical data in response to the second control signal.

Further in accordance with embodiments consistent with the present invention, there is provided a software development and support circuit for monitoring and controlling operation of a computer processing circuit, comprising: a command control component for generating a support control signal, wherein the support control signal is generated from numerical data relating to an internal status of the computer processing circuit; and a computing component for receiving the support control signal, performing one or more calculations based upon the support control signal, and storing one or more results of the one or more calculations.

Other features, and advantages of the present invention will become apparent from the following detailed description. It should be understood, however, that the detailed description and specific examples, while indicating preferred embodiments of the invention, are given by way of illustration only, since various changes and modifications within the spirit and scope of the invention will become apparent to those skilled in the art from this detailed description. The scope of the invention is defined by the claims.

### BRIEF DESCRIPTION OF THE DRAWINGS

The accompanying drawings, which are incorporated in and constitute a part of this specification, illustrate several embodiments and together with the description, serve to explain the principles of the invention. A more complete appreciation of the present invention and many of its attendant advantages will be readily obtained by reference to the following detailed description considered in connection with the accompanying drawings, in which:

FIG. 1 illustrates a block diagram of a conventional digital processing circuit;

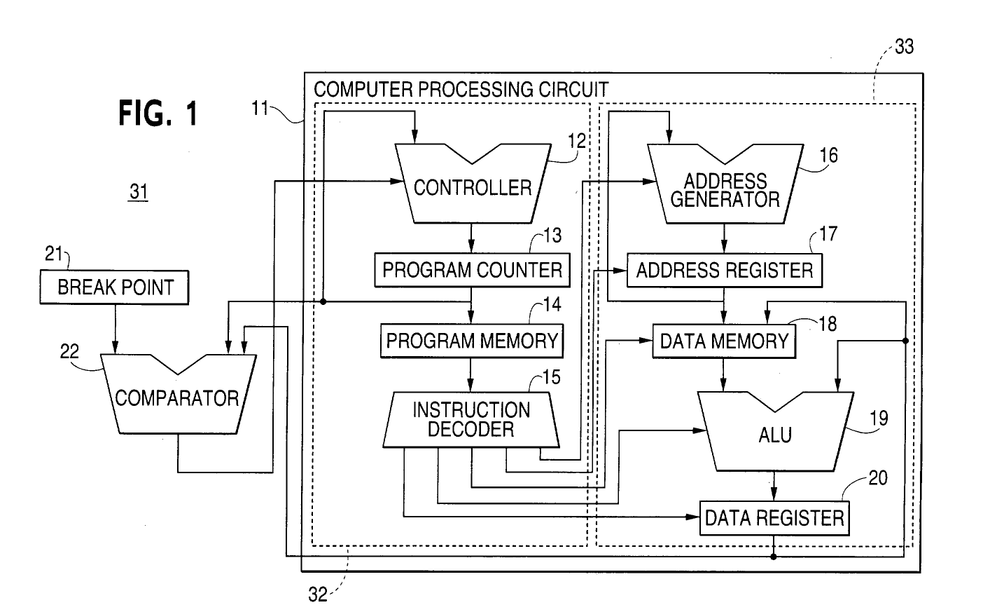

FIG. 2 illustrates a block diagram of a software development support circuit consistent with the present invention; and

FIG. 3 illustrates a block diagram of software development support circuit consistent with the present invention.

### DETAILED DESCRIPTION OF THE EMBODIMENTS

Following is a detailed explanation of a semiconductor integrated circuit embodying a software development and support circuit consistent with an embodiment of the present invention.

The software development support circuit of the present embodiment is characterized in that time, data, and command control status, are specified when the operations of a computer device are verified and, in addition to checking the interior status of a computer device in real time, the interior status can be processed as numerical data through software. Based on the result, commands such as stopping the functions of the computer device can occur. The software development support circuit of the present embodiment is formed at a specific location in the chip or in the wafer.

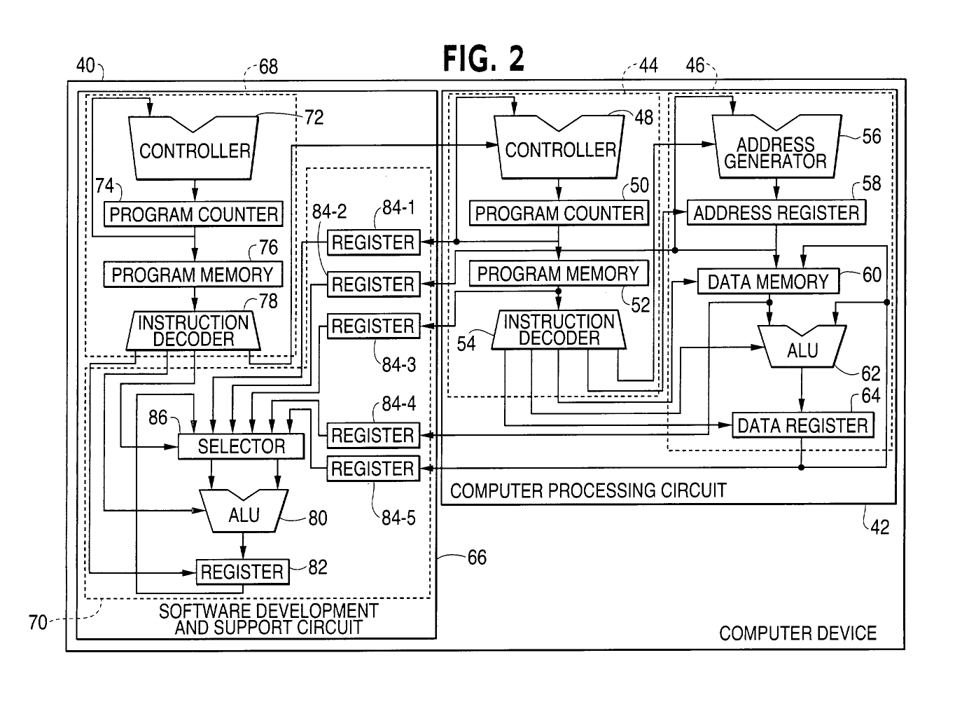

FIG. 2 is a block diagram of a software development support circuit 10 for a computer device consistent with the present embodiment.

A computer device 40 includes a computer processing circuit 42. Circuit 42 comprises first command control component 44 to control operations related to calculation and first computing component 46 to perform calculations based on a computing control signal from the first command control component 44.

First command control component 44 has a controller 48, a program counter 50, a program memory 52, and an instruction decoder 54.

Controller 48 controls the operation of program counter 50. Recorded in program memory 52 is a prescribed computer program. Program counter 50 generates an address to execute the prescribed program. Instruction decoder 54 decodes data read from program memory 52 and supplies the computing control signal to first computing component 46.

First computing component 46 has an address generator 56, an address register 58, a data memory 60, an arithmetic logic unit (ALU) 62, and a data register 64.

Recorded in data memory 60 is data for use in calculations. Address generator 56 generates an address to read data recorded in data memory 60. Address register 58 temporarily stores this address. ALU 62 performs prescribed calculations. Data register 64 temporarily stores the calculations of ALU 62.

A software development and support circuit 66 receives in the internal status of circuit 42 as numerical data and, in addition, computes numerical data based on a software program. Software development and support circuit 66 may be included as part of computer device 40 as illustrated.

The internal status may include control signals, data, operational results and the status of operational flags. Furthermore, operations may include addition, subtraction, multiplication division, bit handling, and match/no-match decisions.

Software development and support circuit 66 includes a second command control component 68 to generate a support control signal to compute numerical data, and a second computing component 70 to actually perform calculations based on the support control signal from second command control component 68.

Second command control component 68 of the software development and support circuit 66 comprises a controller 72, a program counter 74, a program memory 76, and an instruction decoder 78.

Controller 72 controls the functions of program counter 74. Recorded in program memory 76 is a prescribed program to process numerical data that is the internal status of computer circuit 42 in an arithmetic format. Program counter 74 generates an address to execute this prescribed program. Instruction decoder 78 decodes data read from program memory 76 and the support control signal is provided to second computing component 70 of the software development and support circuit 66.

Second computing component 70 of software development and support circuit 10 comprises an Arithmetic Logic Unit (ALU) 80 and a data register 82.

ALU 80 executes prescribed calculations for the numerical data that is the arithmetically processed internal status of circuit 42. Data register 82 temporarily stores the calculation results of the ALU 80.

Registers 84-1, 84-2, 84-3, 84-4, and 84-5 temporarily store the numerical data that is the arithmetically processed internal status of circuit 42 detectable in real time.

For example, the data of program counter 50 can be stored in register 84-1, the data of the address register 58 can be stored in register 84-2, and the data read from program memory 52 can be stored in register 84-3. Furthermore, data read from data memory 60 is stored in register 84-4 and data of data register 64 can be stored in register 84-5.

A selector 86 selectively provides one from among the various sets of data in registers 84-1, 84-2, 84-3, 84-4, and 84-5 to the ALU 80.

In this type of software development and support circuit 66, it is the case that initially, owing to the presence of registers 84-1, 84-2, 84-3, 84-4, and 84-5, the status of the various components inside the computer circuit 42, or more specifically the data of the program counter 50, the data read from the program memory 52, the data of the address register 58, the data read from the data memory 60, and the data of the data register 64, can be detected, respectively, in real time.

Secondly, numerical data relating to the internal status of circuit 42 detected in real time is selectively inputted to ALU 80 from selector 86. ALU 80 executes prescribed calculation based on preset processing sequences and conditions, for example, based on program memory 76. Afterwards, software development and support circuit 66 executes prescribed functions, such as stopping the operation of device 40, when the results processed by second computing component 70 satisfy specific conditions. Therefore, software development and support circuit 66 has, in a manner analogous to circuit 42, second computing component 70 to execute calculations, and second command control component 68 to control calculations in second computing component 70.

Second computing component 70 computes, as numerical data, the data of various components in circuit 42, for example, the command data (data read from the program memory 52), signals displaying the status of internal components (data of program counter 50 and address register 58), data used in numerical calculations (data read from the data memory 60), and computer results and result flags (data of the data register 64).

Further, these calculations occur in accordance with a sequence and conditions recorded in program memory 76 or second command control component 68.

Hence, in accordance with operation of software development and support circuit 66, a command (which can be detected from the output data of the program memory 52) and the results of mathematical calculations according to that command (data detectable from the data register 64) can be detected at a specific time (when data is detectable from the program counter 50). Based on these results, a determination can be made as to whether or not to stop operations of computer device 40.

Further, for example, when data from program counter 50 can be detected, a command detectable from output data of the program memory 52 and the results of mathematical calculations based on that command data detectable from the data register 64 are detected. Based on those results, a determination is made as to whether or not to stop operations of computer device 40.

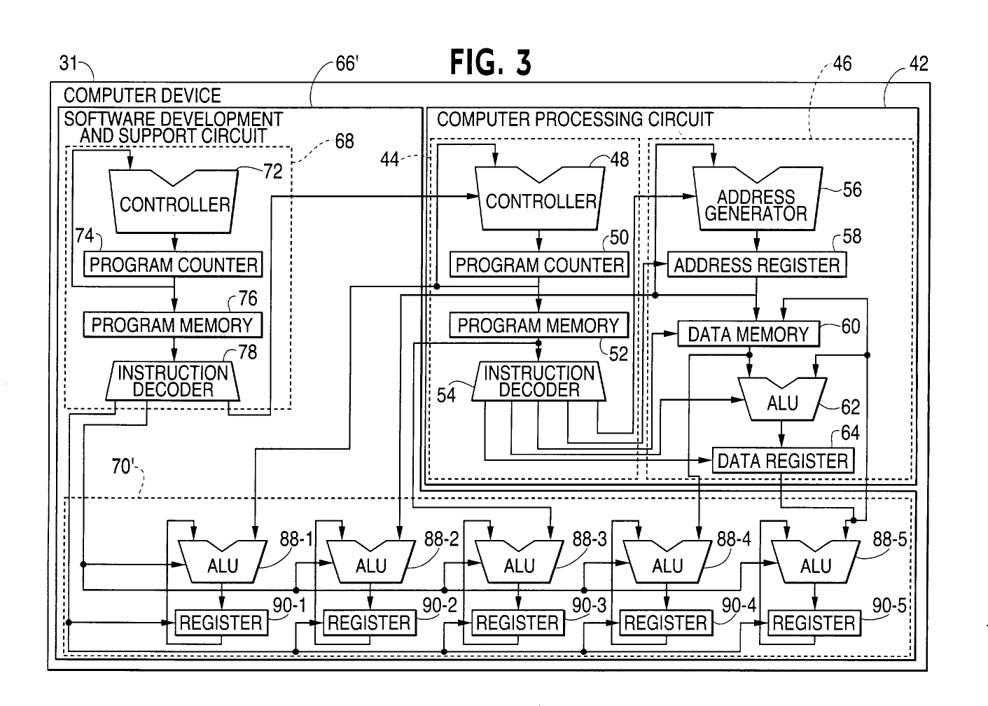

FIG. 3 is another embodiment of software development and support circuit 66 consistent with the present invention.

In FIG. 3, instead of software development and support circuit 66 having multiple registers and a selector to produce the internal status of the computer circuit as numerical data, a software development and support circuit 66′ has multiple ALUs to execute calculations and multiple data registers to store calculation results.

In contrast to circuit 42, software development and support circuit 66′ has second command control component 68 to generate the support control signal to process numerical data based on software and a second computing component 70′ to calculate based on the support control signal from second command control component 68.

Second computing component 70′ comprises ALUs 88-1, 88-2, 88-3, 88-4, and 88-5, and data registers 90-1, 90-2, 90-3, 90-4, and 90-5.

ALUs 88-1, 88-2, 88-3, 88-4, and 88-5 perform prescribed calculations for numerical data that is the internal status of circuit 42. Data registers 90-1, 90-2, 90-3, 90-4, and 90-5 temporarily store the calculation results of ALUs 88-1, 88-2, 88-3, 88-4, and 88-5.

In software development and support circuit 66′, the status of various components in the computer circuit 42 (specifically, data from program counter 50, data read from program memory 52, data from address register 58, data read from data memory 60, and data from data register 64), can each be detected in real time.

Secondly, numerical data pertaining to the internal status of circuit 42 detected in real time, is computed by ALUs 88-1, 88-2, 88-3, 88-4, and 88-5. ALUs 88-1, 88-2, 88-3, 88-4, and 88-5 perform prescribed calculations according to a preset process sequence, and conditions according, for example, to program memory 76.

Then, if the results processed by computing component 70′ satisfy specified conditions, software development and support circuit 66′ performs prescribed functions such as stopping the operations of device 40.

Software development and support circuit 66 or 66′ has, in a manner analogous to the computer circuit 42, second computer component 70 or 70′ to execute calculations and second command control component 68 to control calculations in second computing component 70 or 70′. Second computer component 70 or 70′ computes the data of various components on circuit 42 as numerical data. The numerical data can be the command data (data read from program memory 52), signals that indicate the internal status of control signals (data of the program counter 50 and the address register 58), data used for numerical calculations (data read from the data memory 60), and the calculation results and result flags (data of the data register 64).

Further, these calculations may occur according to processing sequences and conditions recorded in program memory 76 of second command control component 68.

Hence, with software development and support circuit 66 or 66′, the command detectable from the output data of the program memory 52 and the results of mathematical calculations according to that command, which may be data detectable from data register 64, can be detected at a specific time. The specific time may be when data is detectable from the program counter 50. Based on those results, a determination is made as to whether or not to stop operations of computer processing circuit 42.

Furthermore, for example, when data from program counter 50 is detectable, commands detectable from output data of program memory 52 and the results of mathematical calculations based on those commands, which is data detectable from data register 64, are detected. Based on those results, a determination is made as to whether or not to stop operations of computer processing circuit 42.

Software development and support circuits consistent with the present invention may be implemented in a single chip with circuit 42. Also, software development and support circuits consistent with the present invention may be implemented in the dicing line of a wafer separate from circuit 42.

Software development and support circuits consistent with the present invention may be applied to a computer device used in a portable information device, such as a cellular telephone. Software development and support circuits consistent with the present invention can be equipped with a portable information system, for example, a cellular phone or a portable computer. The portable information system receives information via a receiving device, for example, an antenna, modem jack or screen, and calculates the information.

As explained above, when a software development and support circuit consistent with the present invention can verify the operations of a computer circuit, time, data, command control status are specified and, together with detecting the internal status of the computer device, this internal status is processed as numerical data. Based on these results, a determination can be made as to whether or not to execute controls such as stopping the operation of the computer device.

Hence, despite computer devices in recent years using complex software programs, the software can be checked by setting a processing sequence and conditions with software used in software development and support circuits consistent with the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed:

1. A computer device comprising:
a computer processing circuit having a first computing component and a first command control component, said first computing component for performing calculations in accordance with a first control signal, said first control signal being generated based on a first program;
a software development and support circuit having a second computing component and a second command control component, said second computing component for calculating in accordance with a second control signal, said second command control component for creating said second control signal based on a second program; and
wherein said software development and support circuit receives information of computing status of said computer processing circuit as numerical data, and said second computing component performs calculations on said numerical data responsive to said second control signal.

2. The computer device according to claim 1, wherein said information of computing status includes control signals, data, calculation results, and a calculation flag.

3. The computer device according to claim 1, wherein said software development support circuit determines, based on results of the calculations of said second computing component, whether or not to stop operations of said computer processing circuit.

4. The computer device according to claim 1, said first computing component further comprising:
a support circuit to support calculation data; and
a calculation device to perform calculations.

5. The computer device according to claim 1, said first computing component further comprising:
an address generator to create an address;
an address register to store said address;
a memory to hold calculation data based on said address;
a calculation device to perform calculations on said calculation data according to said first control signal; and
a data register to store an output of said calculation device.

6. The computer device according to claim 5, wherein said numerical data includes at least one of data stored by said address register, said calculation data held in said memory, and data stored by said data register.

7. The computer device according to claim 5, wherein said first computing component calculates said calculation data according to a prescribed order and conditions based on said first control signal.

8. The computer device according to claim 1, said first command control component further comprising:
a program counter to generate an address;
a controller to control said program counter;
a program memory to output command data based on said address; and
an instruction decoder to create said first control signal based on said command data.

9. The computer device according to claim 8, wherein said numerical data includes at least one of data from said program counter and said command data output from said program memory.

10. The computer device according to claim 1, said second computing component further comprising:
a calculation device to perform calculations on said numerical data according to said second signal; and
a first register to store the output signal of said calculation device

11. The computer device according to claim 10, said second computing component further comprising:
a second register to store said numerical data; and
a selector to selectively supply said numerical data to said calculation device.

12. The computer device according to claim 10, wherein said software development and support circuit determines, based on data stored in said first register, whether or not to stop operations of said computer processing circuit.

13. The computer device according to claim 1, said second command control component further comprising:
a program counter to create an address;
a controller to control said program counter;
a program memory to output command data based on said address; and
an instruction decoder to create said second control signal based on said command data.

14. The computer device according to claim 1, wherein said software development and support circuit determines, based on an internal status of said computer processing circuit at a specific time, whether or not to stop operations of said computer processing circuit.

15. The computer device according to claim 1, wherein said software development and support circuit determines, based on an internal status of said computer processing circuit at multiple different times, whether or not to stop operations of said computer processing circuit.

16. The computer device according to claim 1, wherein said computer processing circuit and said software development and support circuit are formed within one chip.

17. The computer device according to claim 1, wherein said computer processing circuit is used in digital signal processors or in portable information systems.

18. A portable information system comprising:
a receiving device to receive information;
a computer processing circuit, which processes said information, having a first computing component and a first command control component, said first computing component for performing calculations in accordance with a first control signal and said first control signal being generated by said first command control component based on a program;
a software development and support circuit having a second computing component and a second command control component, said second computing component calculating in accordance with a second control signal, said second command control component generating said second control signal based on a program; and
wherein said software development and support circuit receiving information of computing status of said computer processing circuit as numerical data, said second computing component processing said numerical data in response to said second control signal.

19. The portable information system of claim 18, wherein said receiving device is an antenna.

20. The portable information system of claim 18, wherein said receiving device is a modem jack.

21. The portable information system of claim 18, wherein said portable information system is a cellular phone.

22. The portable information system of claim 18, wherein said portable information system is a portable computer.

23. The portable information system of claim 18, further comprising a display screen.

24. The portable information system of claim 18, wherein said display screen receives information.

25. A software development and support circuit for monitoring and controlling operation of a computer processing circuit, comprising:
a command control component for generating a support control signal, wherein the support control signal is generated from numerical data relating to an internal status of the computer processing circuit; and
a computing component for receiving the support control signal, performing one or more calculations based upon the support control signal, and storing one or more results of the one or more calculations.

26. The software development and support circuit of claim 25, wherein the internal status includes control signals, data, calculation results, and a calculation flag.

27. The software development and support circuit of claim 25, wherein said command control component determines, based on the one or more results, whether or not to stop operations of the computer processing circuit.
